(19) United States
(12) Patent Application Publication
(10) Pub. No.: US 2013/0206825 A1
(43) Pub. Date: Aug. 15, 2013

(54) ENVELOPES AND METHODS FOR THEIR PRODUCTION

(71) Applicant: Christian Macgregor, New South Wales (AU)

(72) Inventor: Christian Macgregor, New South Wales (AU)

(73) Assignee: MACGREGOR MANUFACTURING INVESTMENTS PTY LIMITED, New South Wales (AU)

(21) Appl. No.: 13/882,139

(22) PCT Filed: Oct. 27, 2011
(86) PCT No.: PCT/AU2011/001381

§ 371 Date: Apr. 26, 2013

(30) Foreign Application Priority Data
Oct. 27, 2010 (AU) 2010904780

(51) Int. Cl. B65D 27/14; B31B 23/00; B31B 1/64

(52) U.S. Cl. CPC B65D 27/14; B31B 1/64; B31B 23/00
USPC 229/80; 493/199; 493/214; 493/243

(57) ABSTRACT

An envelope is formed from continuous COPP film web by precreasing envelope body (13) and flap (14) fold lines along the web, continuously installing an adhesive tape along the flap portions and pre-cutting relief slots in the web corresponding to the flap side edges (15). The pre-creased web is folded and cut into individual envelopes by hot knife cutting, whereby the presence of the slots prevents the flaps from welding to the side seams even with the flap folded over. Envelopes produced by the method are suited to automatic stuffing. Apparatus for making envelopes in accordance with the invention is also described.

### FIELD OF THE INVENTION

This invention relates to envelopes and methods for their production. The invention particularly relates to envelopes capable of being made and stuffed by machine, and for illustrative purposes the invention will be described with reference to this application. However we envisage that this invention may find use in other applications such as production of envelopes for hand or machine stuffing generally.

### BACKGROUND OF THE INVENTION

The reference to any prior art in this specification is not, and should not be taken as, an acknowledgement or any form of suggestion that the referenced prior art forms part of the common general knowledge in Australia.

Paper envelopes represent the original art and are generally die cut and glued to form a stock of open or closed-flap envelopes. The flaps are generally provided with a moistenable adhesive layer or a high tack acrylic adhesive layer protected by a release film.

Machine packaging of print articles for postage is typified by plastic wrap manufactured from thin polyethylene (PE), wrapped around the product, sealed at both ends and provided with a sealed seam down the middle on one side. Once opened it can't be resealed, takes shape of a plastic tube not an envelope. It doesn't have a flap for insertion or allow reopening/closing and doesn't take on the attributes of an envelope to run through inserting equipment. The postal information (postage paid status, addressee and return address information) must be provided on a separate sheet to be viewed through the transparent film.

Plastic pockets are known and generally take the form of an envelope formed of polymer sheet by creasing bottom and flap folds, folding to form an open-flapped blank and then hot sealing and cutting to form the closed side edges.

Machine stuffing envelopes have been formed in paper and plastics materials. For example, paper based envelopes are diecut and glued to form an open flapped envelope. Synthetic based envelopes may be diecut and glued. Envelopes have been formed of TYVEC® or other polyethylene based material, YUPO® and other clear or opaque polypropylene based material, or laminates such polyester films having thermoplastic heat-sealable layers and/or abuse layers. Plastic envelopes with open flap may be produced in 25-60 micron blown biaxially-oriented polypropylene (BOPP).

Machine stuffable envelopes must be relatively stiff. Accordingly many paper and PE envelopes are not suited to machine stuffing. Whether paper or plastic, envelopes are invariably prepared as machine stuffed envelopes with the flap open; the stuffed envelopes must then be closed and sealed. A polymer envelope cannot be formed with the flap down because of the side sealing trapping the flap to at least some degree. This interferes with envelope stuffing machinery configured to stuff a flap-down envelope. Plastic wraps formed about the product are necessarily of soft PE or PVC film and cannot be overprinted.

### SUMMARY OF THE INVENTION

In one aspect the present invention resides broadly in an envelope including:
a polymer film envelope body portion having heat sealed side seams and a top opening; and
an integral flap portion closed over said top opening and having respective side edges each relieved to the respective intersection of the side edge with an adjacent said side seam.

The presence of the relieved portion permits the envelope side edges to be heat sealed and cut in manufacture with the flap closed without inadvertently sticking the flap side edges down to the envelope body.

The heat sealable polymer film may be selected from monolayer or laminated polymer films. For example the polymer film may be selected from biaxially oriented polyolefin films. Such films are generally isotactic (stereoregular) semicrystalline polymers, capable of extrusion casting and reaching relatively high modulus on biaxial orientation. In order that the envelopes be machine stuffable, the polymer film may be selected from polymer films having a selected film stiffness or flexural modulus. For example, a film having the flexural characteristics of 120 μm clear cast polypropylene may be used. Biaxially oriented polypropylene has a packaging advantage of becoming crystal clear on orientation. The polymer film may be selected to be printable, either as a matter of choice of material or by pr or post treatment such as corona treatment.

The integral flap portion may be provided with a release film-covered pressure sensitive adhesive layer.

The relief of the respective side edges may comprise trimmed side edges of the flap extending from the outer edge of the flap to at least to said fold line. The relief may comprise a parallel, tapered or shaped relief terminating in a squared or curved transition to the side seam adjacent the fold.

The relief of the respective side edges to the respective intersection of the side edge with an adjacent side seam may be done during formation of the envelope blank from a continuous roll. The relief may comprise a slot in a polymer web extending from a putative flap outer edge to at least a crease line dividing the flap portion from the envelope body blank portion and may have a shaped inner end such as a square edged, rounded edged or tulip shaped inner end. The slot may extend past the crease line per se to ensure that the folding crease is free from inhibition by heat sealing/cutting artefacts.

In a further aspect the invention is a method of producing an envelope from a polymer film web, including the steps of:
forming a flap fold line in a heat sealable polymer film envelope blank to define a flap portion and an envelope body portion;
relieving said flap portion from an outer edge to intersect said fold line to form opposed flap side edges;
folding the blank about the flap fold line and a sleeve fold line parallel to and spaced from the flap fold line to form a closed flap envelope form, and
heat sealing and cutting the closed flap envelope form to form sealed side edges on the envelope body spaced from the flap side edges.

The polymer web may be selected from laminates with thermoplastic outer layers or monofilms of thermoplastic. For example the film may be selected from clear cast polypropylene film (COPP or CPP) and a clear cast degradable polypropylene.

The web may be subjected to corona treatment to render the material suitable for some printing applications.

The material may be any thickness selected to provide sufficient form stability for machine stuffing. For example typical thicknesses will be in the region of 90 micron (μm) to 150 μm. Standard COPP film of 120 μm may be used. Relative rigidity enables the envelopes to be held in the loader of an inserting machine. Relative rigidity is also required for the suction heads used throughout inserting machines.

The flap and/or the envelope sleeve overlaid by it may be provided with a pressure sensitive adhesive layer to enable sealing. The pressure sensitive adhesive may be in the form of a tape. The adhesive layer may instead be a heat-activated or hot melt adhesive. Alternatively, sealing means may be added after stuffing.

Printing may be applies either a process step involving the continuous web or as a port production on the formed or stuffed envelopes. Printing may be by means of any suitable process including but not limited to a digital printing head, flexographic or hot foiling process.

The polymer may be provided as a flat continuous film on rolls. The continuous roll may be provided or slit to form a roll of width selected by adding the envelope front height, the envelope back height and the flap height.

The continuous web may be creased by crush rollers acting along the machine direction to form continuous fold lines. For example, the web may be crush-creased to approximately 80% of the depth of material thickness at a position of the fold to form the bottom of the envelope. The continuous web may be passed over a folding triangle to which folds the material at the position of the crease. Heat may be applied to the bottom of the envelope at the fold to aid the fold and reduce material elastic memory (spring back). Similarly the film may then be crush creased in a position to fold and form the flap, with heating as appropriate.

Envelope closure tape may be continuously applied if required, to either the flap or pocket portions of the envelope under a tension controlled tape application unit.

The pre folded web may be spread and driven through a continuous punching station where the web may be indexed for punching a slot to provide the relieving of the flap portion from an outer edge to intersect said fold line to form opposed flap side edges. This slot allows the sealing head to seal the sides of envelope without sealing the flap to the same sides of the envelope. The slot may be a basic straight sided and square or round cornered slot or may be more shaped.

The envelope web may be passed through a pre-fold section that has a shaped bar and rollers that rolls and folds the flaps over into a closed position. A gripper and heat source may be used to enforce the fold and aid the crease so there is no spring back in the material.

The slot may be indexed with a heat sealing/cutting knife by any suitable means such as a sensor. The heat sealing and cutting is by hot knife means. The knife cuts the sides of the envelope along a line spaced from the notch edge and misses the flap while sealing closed the sides of the individual envelopes, which may then pass to a picking unit. The picking unit may deliver the envelopes to the batch unit for quality checking prior to packaging into cartons.

### BRIEF DESCRIPTION OF THE DRAWINGS

The invention will be described with reference to the following non-limiting example of the invention, in which particular features and options are illustrated in the drawings wherein:

FIG. 1 is a scheme of an envelope machine for producing envelopes in accordance with the present invention;

FIGS. 2 and 3 are detail views of a special heat seal knife/stripper assemblies for use in the machine of FIG. 1;

FIGS. 4 and 5 are a plan and section respectively indicating the crush creasing layout of a continuous web suitable for use in the method of the present invention;

FIG. 6 is plan view of a polymer web illustrating (only) the relation between that flap fold and slots; and

FIG. 7 is a view of alternative slot forms in relation to a hypothetical flap fold.

### EXAMPLE

Smooth Clear Cast Oriented Polypropylene (COPP) film was provided on a continuous roll, having a thickness of 120 microns (μm) and corona treated at up to 44 dyne/cm. Typically the film is of tensile strength of greater than about 3-3.5 kg/mm² in both the machine and transverse directions. The material has a heat seal temperature of 130-145° C.

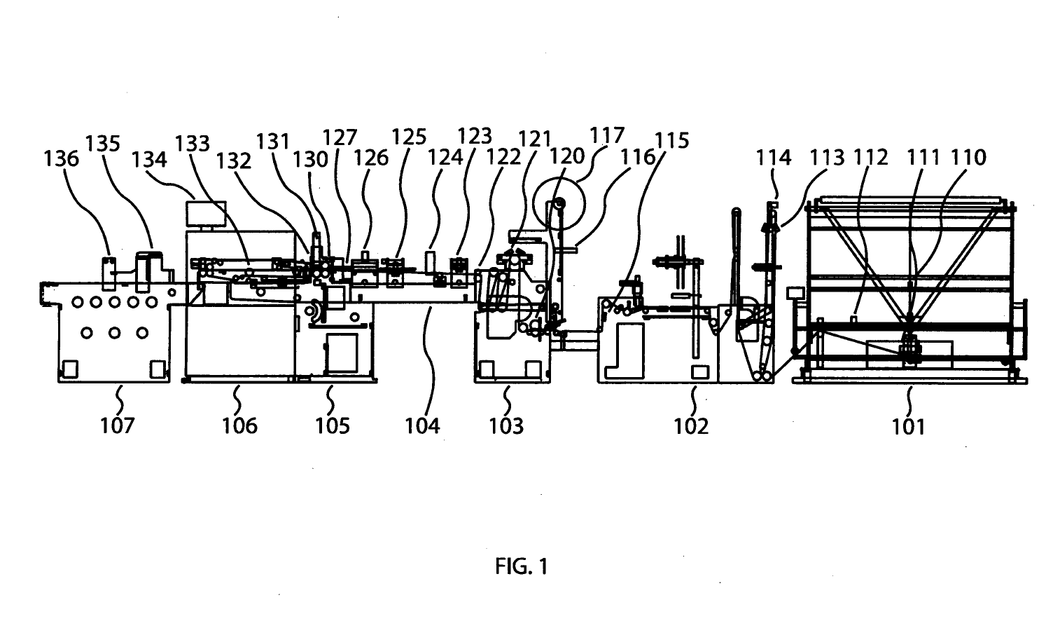

In FIG. 1 there is provided an envelope machine comprising an unwind/fold unit 101 receiving the COPP film web, a gusseting station 102, a material accumulator 103, an accessory bed 104, a seal station 105, a picking unit 106 and a batching unit 107.

The unwind/fold unit 101 includes a creasing station 110 for initial marking out of the web and accompanying heating unit 111. The path is regularized by an edge guide 112 before the web passes to the gusseting station 102. The gusseting station 102 includes heating clamps 113 to soften the polymer, followed by a further creasing station 114. Gussets are cut before the web passes to the material accumulator 103 via a further heating unit 115, before passing up the accumulator.

The material accumulator 103 includes a tape tensioner 116 taking from a tape unit 117 to unite web with coated adhesive tape layer. The assembled, pre-creased and taped web passes through a servo drive accumulator 120 and heating clamps 121 to servo drive accessories station 122.

The accessory bed 104 includes a printing unit 123 and a notch punch 124 relieving the future flap side edges. A flap folding unit 125 is followed by a flap/bottom heated crease unit 126 before the envelopes pass to the seal station 105.

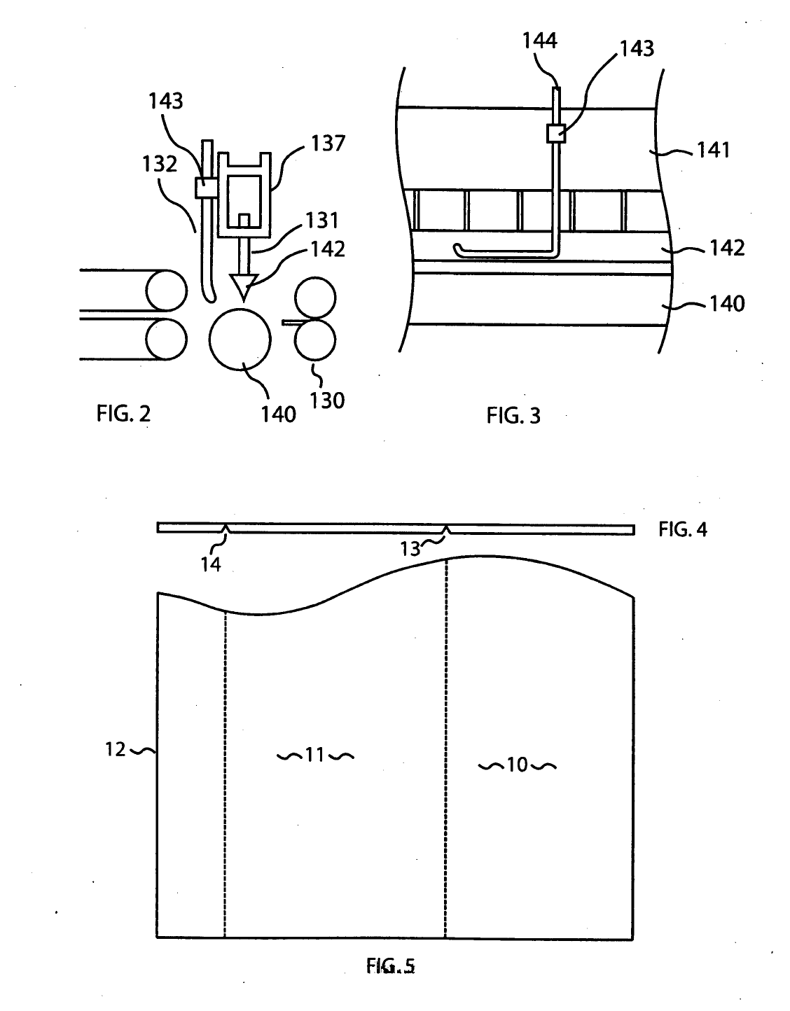

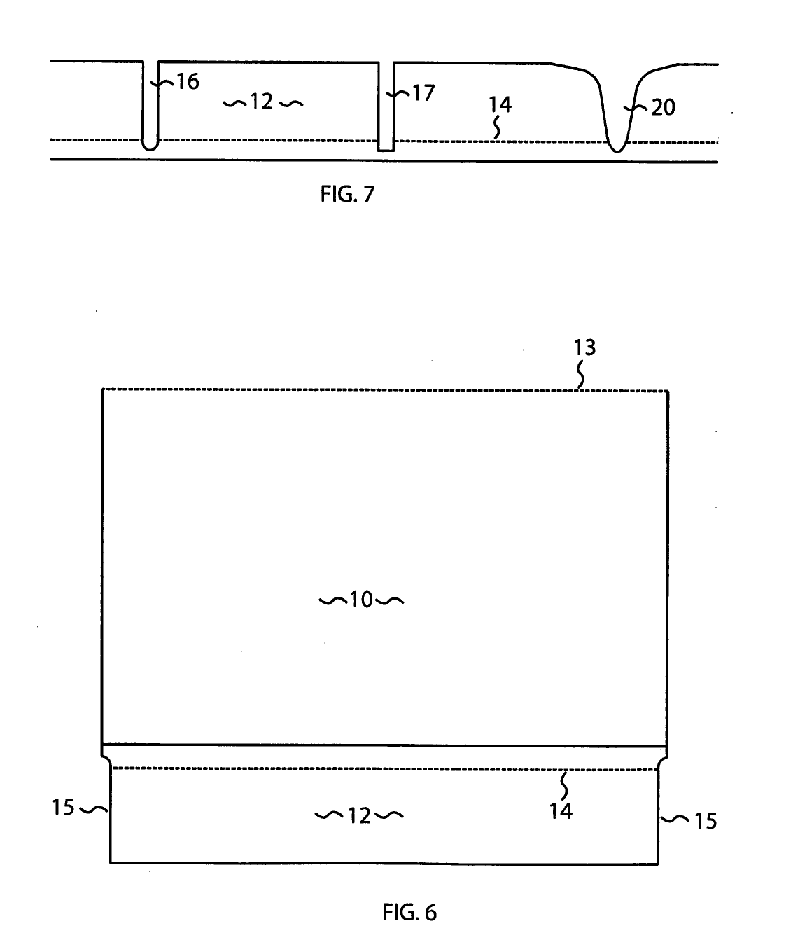

In the seal station 105 a product guide 127 is followed by a servo driven sealing unit 130, illustrated in more detail in FIGS. 2 and 3, and comprising a heated seal/cutting head 131 and a flap guide and stripper assembly 132. The picking unit 106 comprises picking unit belts 133 and is associated with an operation panel 134.

The batching unit 107 includes a collection/stacking unit 135 and a finished batch delivery unit 136.

In FIGS. 2 and 3, the a servo driven sealing unit 130 comprising a heated seal/cutting head 131 including a hot knife assembly 137 and a seal roller 140, and a flap guide and stripper assembly 132. The hot knife assembly 137 includes a sealing knife support frame 141 and a sealing knife 142 movable relative thereto. The stripper assembly 132 includes a mount 143 and a stripper bar 144 adjustably mounted thereto.

The total film width comprises the sum of the envelope front 10 height, the envelope back 11 height and the flap 12 height, illustrated proportionally in FIGS. 4 and 5.

Film is pulled from its roll by a driven variable speed rubber drive roller with an edge positioning system, edge positioning system is required to maintain correct product sizing. Crush creases 13 are made by a steel wheel onto a hardened roller in a position of the film where it's required to fold and form the bottom of the envelope. The film is crushed crease to approx 80% of the depth of material thickness.

The film is guided over a large triangle (folding triangle) which folds the material at the position of the crease. Heat is applied to the bottom of the envelope at the fold to aid the fold and reduce material memory (spring back).

The film is folded and changes direction at 90 degree angle. Crush creases 14 are made by a steel wheel onto a hardened roller in a position of the film where it's required to fold and form the flap. The film is again crush creased to approx 80% of the depth of material thickness. Heat is also applied at the creases and fold to help remove any material memory (spring back).

Envelope closure tape is applied to the flap of the envelope under a tension-controlled application unit. The film is tension controlled and material is gathered in a compensation unit to allow for quick uptake when the machine is starting from a stop position. It also allows for increasing of machine speed. It is important not to stretch the adhesive tape so the product remains flat after manufacture. In this embodiment the closure system is a double coated polyester tape, with a differential acrylic adhesive system. The tape is prescribed for temporary closure for CPP, BPP, LDPE, HDPE plastic film envelopes.

The film is driven through an accessories area of the machine by two servo driven sets of rubber rollers. One set of driven rollers is previous to the bed and the 2nd set is after the accessories bed. This keeps a good continuous tension and enables the film to maintain a precise indexing to length. The film continues past antistatic bars at 2 positions through the machine to remove any static from the plastic. Static will cause the envelopes to stick together at the delivery of the product and cause feeding problems in the envelope inserting machines.

The next step is to produce the relief 15. In the accessories area of the machine a punch cuts a shaped slot from the film. This slot will allow the sealing head to seal the sides of envelope without sealing the flap to the same sides of the envelope. In the drawing FIG. 7, there is illustrated a range of slot configurations including a rip-stop rounded end slot, a plain square ended slot 17 and a profiled slot 20. In each case the slot extends past the crush crease line 14 to ensure that heat sealing artefacts cannot interfere with free operation of the flap 12.

The envelope needs to be supplied with the flap folded in its closed position. The envelope flap goes through a pre-fold section that has a shaped bar and rollers that rolls/folds the flap over into a closed position. A pneumatic gripper and heated bar to enforce the fold that will aid the crease so there is no spring back in the material.

The continuous web passes to a flying sealing knife head for separation of finished envelopes. The notch needs to be located under the sealing knife for sealing. This can be achieved by the sensor locating the notch or correctly indexing the film by measurement.

The sealing knife head comprises a heated sealing blade manufactured from tool steel. The sealing blade is kept to temperature by a thermocouple and temperature controller. CPP at the selected thickness and speed requires 250-300° C. to form a good seal and finish. The correct temperature will be dependent on the film thickness, speed of output required and conditions of the day.

The sealing blade seals onto a 60 shore hard silicone roller covered with a single piece of PTFE coated glass cloth. The roller is also driven from the seal knife head feed rollers so the seal is rotated.

The seal knife head is mechanically driven and locked into the timing of the envelope picking unit. This is required for perfect timing of seal and picking of the envelope from the heated seal blade. To stop the seal from plastic stringing a chilled stripping plate mounted off the sealing head cools the seal quickly.

A picking and delivery unit removes the envelope from the seal blade and deliver it to a batch stacking unit. The picking unit has a hinged top and bottom jaws coming together to pick the envelope at perfect timing dictated by the sealing head. Picking unit delivery belts are manufactured from a smooth rubber as not to roughen the soft side seals of the envelope. The picking unit delivers the envelopes to the batch unit for quality checking prior to packaging into cartons.

It will of course be realised that while the above has been given by way of illustrative example of this invention, all such and other modifications and variations thereto as would be apparent to persons skilled in the art are deemed to fall within the broad scope and ambit of this invention as is set forth in the claims appended hereto.

1. An envelope including:
a polymer film envelope body portion having heat sealed side seams and a top opening; and
an integral flap portion closed over said top opening at a fold line and having respective side edges each relieved to the respective intersection of the side edge with said fold line adjacent said side seam.

2. An envelope according to claim 1, wherein the polymer film is selected from biaxially oriented polyolefin films.

3. An envelope according to claim 2, wherein the polymer film is a film having the flexural characteristics of oriented clear cast polypropylene of about 120 μm thickness.

4. An envelope according to claim 1, wherein the polymer film is selected from inherently printable polymer films and polymer films printable after corona-discharge treatment either before or after formation into an envelope.

5. An envelope according to claim 1, wherein the integral flap portion is provided with an adhesive closure layer selected from a release film-covered pressure sensitive adhesive layer and a heat activated adhesive layer.

6. An envelope according to claim 1, wherein the relief of the respective side edges comprises trimmed side edges of the flap extending from the outer edge of the flap to at least to said fold line.

7. An envelope according to claim 6, wherein the relief comprises a parallel, tapered or shaped relief terminating in a squared or curved transition to the side seam adjacent the fold.

8. An envelope according to claim 7, wherein the relief of the respective side edges to the respective intersection of the side edge with an adjacent side seam is done during formation of an envelope blank from a continuous roll.

9. An envelope according to claim 8, wherein the relief comprises a slot in a polymer web extending from a putative flap outer edge to at least a crease line dividing the flap portion from the envelope body blank portion and having a shaped inner end selected from a square edged, rounded edged or tulip shaped inner end.

10. An envelope according to claim 8, wherein the slot extends past the crease line.

11. A method of producing an envelope from a polymer film web, including the steps of:
forming a flap fold line in a heat sealable polymer film envelope blank to define a flap portion and an envelope body portion;
relieving said flap portion from an outer edge to intersect said fold line to form opposed flap side edges;
folding the blank about the flap fold line and a sleeve fold line parallel to and spaced from the flap fold line to form a closed flap envelope form, and
heat sealing and cutting the closed flap envelope form to form sealed side edges on the envelope body spaced from the flap side edges.

12. A method of producing an envelope from a polymer film web according to claim 11, wherein the web is subjected to corona treatment to render the material suitable for printing.

13. A method of producing an envelope from a polymer film web according to claim 11, wherein the heat sealable polymer film material is of thickness between about 90 micron (μm) to 150 μm.

14. A method of producing an envelope from a polymer film web according to claim 13, wherein the heat sealable polymer film material is clear cast oriented polypropylene (COPP) film of about 120 μm.

15. A method of producing an envelope from a polymer film web according to claim 11, wherein the flap and/or the envelope sleeve overlaid by it is provided with a pressure sensitive adhesive closure layer

16. A method of producing an envelope from a polymer film web according to claim 11, wherein the continuous web is creased by crush-creasing rollers acting along the machine direction to form said sleeve fold line and said flap fold line.

17. A method of producing an envelope from a polymer film web according to claim 16, wherein the web is folded about said sleeve fold line and said flap fold line, said fold lines being heat treated to reduce elastic memory.

18. A method of producing an envelope from a polymer film web according to claim 17, wherein the pre-folded web is spread and driven through a continuous punching station where the web is indexed for punching a slot to provide said relieving of said flap portion from an outer edge to intersect said fold line to form opposed flap side edges.

19. A method of producing an envelope from a polymer film web according to claim 11, wherein the heat sealing and cutting is by hot knife means.

20. A method of producing an envelope from a polymer film web according to claim 11, wherein the individual envelopes pass via a picking unit to quality checking prior to packaging into cartons.
